(19) United States
(12) Patent Application Publication
(10) Pub. No.: US 2002/0023094 A1
(43) Pub. Date: Feb. 21, 2002

(54) Advertising method and system, method and system for transacting an advertising frame and recording media

(76) Inventors: Takenori Kohda, Yamato-shi (JP); Akiko Murakami, Tokyo (JP)

Correspondence Address: IBM Corporation, Dept. C4TA/J2B, 650 Harry Road, San Jose, CA, 95120-6099, US

(21) Appl. No.: 09/887,460

(22) Filed: Jun. 21, 2001

(30) Foreign Application Priority Data
Jun. 22, 2000 (JP) 2000-188523

(51) Int. Cl. G06F 17/30

(52) U.S. Cl. 707/104.1; 707/200

(57) ABSTRACT

The object is to provide a method and system for dynamically changing the advertising contents in the advertising form integral with the contents that can expect a great advertising effect. A contents owner informs the system management server of the advertising frame information. The system provider publishes the advertising frame information. The transaction of the advertising frame reaches an agreement, the system provider notifies the advertising data management server of the advertising frame information. The advertiser pays the advertisement rate, then records the advertising data on the advertising data management server. In response to the request from the user terminal, the system management server reads the digital contents from the digital contents database, and the advertising data from the advertising database, then delivers the digital contents and the advertising data to the user terminal to display the digital contents with an advertisement.

### FIELD OF THE INVENTION

The present invention relates to advertising method, system and medium, and an advertising technology which allows dynamically changing the contents that are delivered accompanying the digital contents such as a moving image.

### BACKGROUND OF THE INVENTION

In general, there are two forms for delivering an advertisement to a viewer (user) along with an image software (contents) such as a drama.

The first is to deliver an advertisement which is created by a creator other than a contents producer, with accompanying the contents. In this form, the contents is discontinuous temporally or spatially. For example, there is an advertising technique commonly used in television broadcasting wherein an image software such as a drama is divided into a plurality of appropriate intervals and a commercial message is inserted between them. Further, there is an advertising technique which displays a banner advertisement by occupying a part of a Web page or the like.

The other one is that a contents producer creates the contents with embedding an advertisement therein in advance, therefore, the advertisement embedded contents are delivered to deliver an advertisement. In this form, since the advertisement have an intimate inseparable relation with the contents, the temporal and spatial continuity of the contents is maintained. For example, goods used by a personage of a drama or a landscape itself reflected in the landscape may become an advertising medium. These are, for example, a beverage that a personage of a drama drinks, clothes he (or she) wears, a bicycle he rides, and a message in a signboard.

These two forms have both advantages and demerits, respectively. In the first advertising form, there are the following advantages. It creates an advertisement and the contents separately, thus even the same contents are able to have an advertisement of a different content. Therefore, it is possible to select an advertising content depending on the delivery time or the delivery place of the contents. An advertiser can effectively deliver an advertisement at an optimum timing and to an optimum region, so that he can expect a great advertising effect. In addition, since the same or different advertisement can accompany the contents each time the contents are delivered, a contents producer or a contents distributor can collect the delivery rate (advertisement rate) from an advertiser at each delivery. It is also possible to set the usage rate of the contents inexpensive since many chances are kept to collect the advertisement rate. When a production and delivery of the contents is accomplished only by the advertisement rate, it is even possible to make the usage rate of contents charge-free (A reception rate of many television broadcasts is actually charge-free). Reduction in the usage rate brings an advantage to a user (viewer).

However, in the first advertising form, since an advertisement and the contents are separated temporally and spatially, there is a problem that the advertisement may be cut by a viewer. In particular, according to the recent progress of digital technologies, it is easy to cut only an advertisement so that the situation is serious for an advertiser. In general, a viewer's desire is to look at the contents, hence in order to impress an advertisement deeply on a viewer, it is necessary to make the advertising contents attractive. Furthermore, generally in the first advertising form, there is no relation between the contents and the advertising contents, so that a viewer who has interest in the contents tends to ignore the advertisement or to pay no attention to the advertisement. That is, unless the attractive advertising contents be made, the advertisement consequently could not impress its contents on a viewer.

On the other hand, the second advertising form has the following advantages. Since the advertisement is embedded in the contents, and the advertisement is made having an intimate inseparable relation with the contents, thus the situation is avoided where a viewer cuts only the advertisement. In addition, since there is no interruption of the contents due to the display of the advertisement, a viewer can easily look at the advertisement (namely the contents), this causes the situation where the advertisement is prone to be accepted in the event. Moreover, a viewer is rarely conscious of it being an advertisement, thereby impressing goods subject to advertising unconsciously on a user. That is, the advertising effect is expected, without making a viewer conscious of the advertising, and without forcing an advertiser's logic on a viewer that he wants a viewer to look at an advertisement.

However, the second advertising form has the following problems. An advertisement is made when the contents are produced, thus a chance to collect the advertisement rate from advertisers is limited to the time when the contents are produced or delivered. Therefore, since a chance to collect the advertisement rate is limited, the producer of the contents tries to raise the production costs by making the delivery of the contents be fee-charging. The fee-charging isn't welcomed by viewers. In addition, a chance to make an advertisement is limited to the time when the contents are produced, thus the variety for selling an advertising frame is limited. For this reason, the advertisement rate for one advertising frame becomes expensive, so it is difficult for an advertiser to utilize a frame, wherein he may be required to bear a part of the production costs as a sponsor for the production of the contents. Furthermore, an advertiser may be required to participate in ordering and producing at the time of production of the contents, thus a temporal constraint occurs. In addition, the advertising contents can not be optimized and can not be customized according to the delivery time and delivery region, thus resulting in the advertising form that imposes many constraints on the advertiser.

It is therefore an object of the present invention to provide a technique for dynamically changing the advertising contents in an advertising form integral with the contents, wherein the high advertising effects are expected.

It is another object of the invention to provide means for transacting an advertising frame embedded in the contents.

### SUMMARY OF THE INVENTION

Now the outline of the present invention will be described. The present invention embeds the advertising frame in the contents, wherein the frame corresponds to an object included in the contents. That is, the contents are produced separately from the advertisement itself, wherein the advertising frame is embedded in the contents. Separate from the contents, the advertising data is generated (produced) so as to match the advertising frame. When the contents are delivered to a user, or when the contents are displayed on the display of the user terminal, the advertising data is synthesized within the advertising frame of the contents, both of which are displayed to the user terminal at the same time. It is noted that the object may be generated at the production stage of the contents or may be generated by cutting out from the original image after the contents are produced.

With this scheme, besides an advertisement integral with the contents is implemented which is similar to the aforementioned second advertising form, the advertising data (the advertising contents) is produced separately from the contents. Hence, there is no demerit as is found in the aforementioned second advertising form. That is, there is provided an advertising form that is expected to bring about high advertising effects and which is easy to use for an advertiser, a contents producer, and a user.

Once an advertising frame is determined, a contents producer can proceed with production of the contents irrespective of the advertising contents. Hence, he can proceed to produce the contents expecting the later advertisement rate, even if no sponsor is secured at the start time of the contents production. The advertising frame can be sold even after the production of the contents as well as before and during the production of the contents. Hence, there is a chance to collect production costs later. Besides, more chances are given than the past. In particular, when it is recognized later that the contents have high topicality, the advertising frame can be sold at a high price, which allows collecting the advertisement rate reflecting the demand.

The advertiser doesn't need to determine participating in the advertising in the production stage of the contents. When it is sold later, he can purchase the advertising frame at a reasonable price that is determined depending on the demand at that time. Also, as he can arbitrarily select the time when he participates in the advertising, he can perform the advertising at an optimum timing. Furthermore, since the advertisement is not inseparable from the contents, the advertising is performed selecting a region where the contents are delivered or a viewer class the contents are delivered to. This allows removing a wasteful advertisement, consequently, higher advertising effects are expected at the same price.

For a viewer, he can look at the contents without being interrupted temporally and spatially, because the continuity of the contents is assured. Also, as the advertisement is integrated together within the contents, he isn't aware of it being the advertisement. In addition, it is expected that the production costs are collected by the advertising, the usage rate of the contents may be set inexpensive. In some cases, the usage rate of the contents may be made charge-free. The decrease of the usage rate promotes the utilization of the contents, which is expected to bring about greater advertising effects, thus leading to the merits of the advertiser.

Moreover, the present invention provides a transaction method of the aforementioned advertising frame. That is, there is provided a system provider between a contents producer, an advertiser and a contents user.

The contents producer produces the contents embedding the advertising frame and commissions the system provider to sell the advertising frame. At this time, the preferred sales price may be followed. When the system provider undertakes the sales, he is provided with the information about the advertising frame from the contents producer. Also, the contents are recorded in the contents database. The contents database is preferably, but not limited to, recorded in a recording apparatus of a computer system that is managed by the system provider. In the case of the contents that were already produced (such as a movie of analog data and a television picture), the system provider (or someone who receives a commission from the contents owner) may cut out an object from the contents and perform the digital processing for associating the object with the advertising frame.

The system provider publishes the sales information of the commissioned advertising frame using, for example, the Internet. Those who can access the published sales information of the advertising frame are an advertiser (or an agent for the advertiser such as an advertising agency). The sales information of the advertising frame may be added with information which allows determining the advertising effects, such as the contents and an object, or the sales price of the advertising frame, and other information such as a limitation clause.

An advertiser (or agent) who hopes to purchase an advertising frame offers the purchase of the advertising frame to the system provider, and is notified the advertising frame information from the system provider when the transaction reaches an agreement. The notification of the advertising frame information may be contingent upon the payment of part or full of the sales price. An advertiser who acquired the advertising frame information produces the advertising data matching the advertising frame information. The production of the advertising data may be performed by others who received a commission. The advertising data produced by the advertiser is recorded in the advertising database. The advertising database is preferably, but not limited to, recorded in a recording apparatus of a computer system that is managed by the system provider. The advertising frame may be accompanied by the contents delivery data such as the delivery time, delivery period and delivery region as an attribute. These attributes relating to the contents delivery are part of the advertisement execution contract, which is of course reflected in the price of the advertising frame.

When the contents are actually delivered, the contents are read from the contents database and the advertising data is read from the advertising database, those of which are delivered to the user terminal. Then, the contents are displayed with the advertisement on the display of the user terminal. Note that the synthesis of the advertising data into the advertising frame of the contents may be performed before the delivery time or at the time it arrives at the user terminal. In addition, the advertisement rate may be collected every delivery.

With such a transaction method of the advertising frame, a robust trading market is formed for the advertising (or advertising frame), thus a reasonable price is formed both for an advertiser and a contents producer (contents owner). Further, an advertiser can get a timely advertising medium, while a contents producer is given a chance to collect the production costs. Also, a contents user can benefit from the decrease of the usage rate of the contents.

A system provider can collect the usage rate of the system from those who use the present system (i.e., a contents producer, an advertiser, etc.) or collect a handling fee each time the transaction of the advertising frame reaches an agreement. Also when he delivers the contents (the advertising data), he can collect a handling fee every delivery. Moreover, the system provider can purchase the contents (or its copyright) from the contents producer or the contents owner, or purchase the reproduction right and behave as a contents owner or the like.

### BRIEF DESCRIPTION OF THE DRAWINGS

FIG. 1 is a conceptual diagram showing an outline of an advertising system of the present invention.

FIG. 2 is a block diagram showing an outline of the configuration of the system management server 10.

FIG. 3 is a block diagram showing an outline of the configuration of the digital contents management server 20.

FIG. 4 is a block diagram showing an outline of the configuration of the advertising data management server 30.

FIG. 5 is a block diagram showing the configuration of the user terminal 40.

FIG. 6 is a block diagram illustrating an example of operations of the present advertising system.

FIG. 7 is a diagram showing a concept of embedding an advertising frame into the digital contents and introducing the advertising data into the advertising frame.

FIG. 8 is a diagram showing a concrete example of an advertising frame.

FIG. 9 is a diagram showing a concrete example of another advertising frame.

FIG. 10 is a diagram showing a further concrete example of an advertising frame.

FIG. 11 is a diagram showing an example where annotation information is applied.

FIG. 12 is a diagram illustrating a flow from the contents production to the sales of the advertising frame.

FIG. 13 is a flowchart showing an example of the step of embedding an advertising frame.

FIG. 14 is a diagram illustrating a flow when a user looks at the digital contents.

FIG. 15 is a flowchart of an example of synthesis processing of step 90 shown in FIG. 14.

FIG. 16 is a flowchart of an example of synthesis processing of step 95 shown in FIG. 14.

### DETAILED DESCRIPTION OF THE PREFERRED EMBODIMENTS

Now the embodiment of the present invention will be described referring to the attached drawings. The present invention can be implemented by numerous different forms, so it is not limited to the embodiments described herein. It is noted that the same reference numbers are used for the same elements throughout the drawings.

The present invention will be mainly described as a method and system, however, as is understood by those skilled in the art, the present invention is also implemented as a medium that records a program usable in a computer. Therefore, the present invention can take a form of hardware, software, and a combination thereof. A medium that records a program may be any computer readable medium, including a hard disk, CD-ROM, optical storage, magnetic storage, etc.

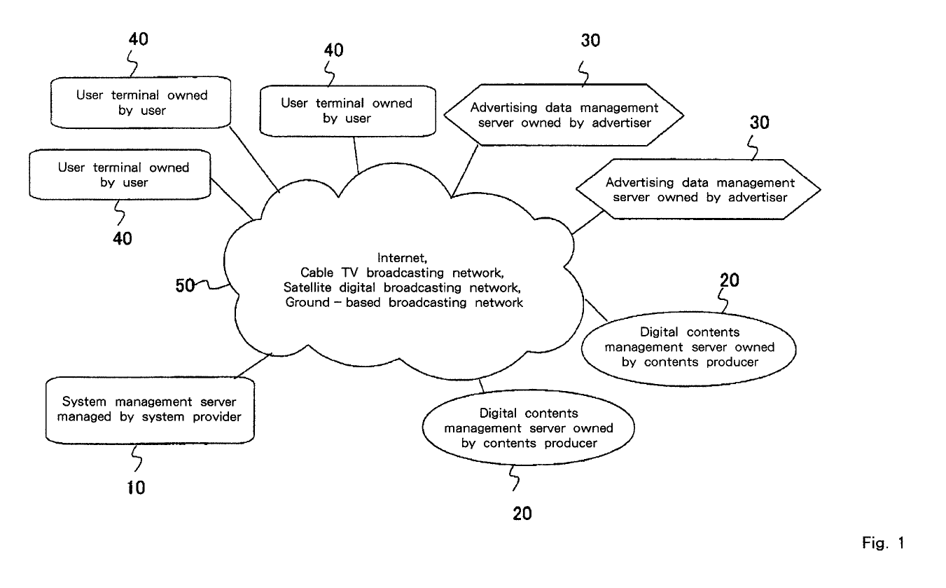

FIG. 1 is a conceptual diagram showing an outline of an advertising system of the present invention. The advertising system comprises a system management server 10, a digital contents management server 20, an advertising data management server 30, and a user terminal 40. The system management server 10 is managed by a provider of the present system. The digital contents management server 20 is owned by the producer of the digital contents. The advertising data management server 30 is located at the advertiser, while the user terminal 40 is located at the user (viewer) of the digital contents. A plurality of digital contents management servers 20, advertising data management servers 30, and user terminals 40 may be included.

The system provider may be the contents producer at the same time, or may be the advertiser. That is, the functions of the digital contents management server 20 may be incorporated into the system management server 10, or the functions of the advertising data management server 30 may be incorporated into the system management server 10. The contents producer includes the owner who received an assignment of the contents or a person who substitutes for a contents producer. The advertiser includes a person who substitutes for the advertiser, such as an advertising agency.

Each server such as a system management server and a user terminal may be a typical computer system. The computer system includes a central processing unit (CPU), a main memory (RAM), a nonvolatile storage (ROM), etc., all of which are interconnected by bus. Also connected to the bus are co-processors, an image accelerator, a cache memory, an input/output (I/O) controller. Furthermore, an external storage, a data input device, a display device, and a communication controller are connected to the bus through an appropriate interface. Besides, it goes without saying that hardware resources that are generally provided for a computer system may be provided. An external storage is typically a hard disk, however, including a semiconductor storage such as a magneto-optical storage, optical storage, flash memory as well. A read only storage such as a CD-ROM usable for reading data is also included in the external storage, when they are used for reading data or a program. The data input device includes an input device such as a keyboard, and a pointing device such as a mouse. The data input device also includes an image reading device such as a scanner and a voice input device. The display device includes a CRT, an LCD, a plasma display, etc.

A computer system includes various kinds of computers, such as a personal computer, a workstation and a mainframe computer. A computer system used as the system management server 10, the digital contents management server 20, the advertising data management server 30, and the user terminal 40 may be any computer system such as the aforementioned personal computer. The system provider who may deal with a relatively large amount of data preferably uses a system with a high processing speed (mainframe computer, workstation, etc.), while a user is expected to use an inexpensive system (television receiver, personal computer, etc.). However, the present invention doesn't intend to limit uses depending on the processing speed of the system.

Each computer system (i.e., the system management server 10, the digital contents management server 20, the advertising data management server 30, and the user terminal 40) is interconnected by the communication network 50, such as the Internet, a cable television broadcasting network, a satellite digital broadcasting network, and a ground-based broadcasting network. A communication line used for these connections may be either a dedicated line or a public line. A wireless line may be also used. All servers or terminals don't need to be interconnected. For example, the system management server 10 may be a hub, while the other servers and terminals may be connected like a spork.

Each server or a user terminal doesn't need to be implemented by a single system, and may be dispersively processed by a plurality of system. That is, a part of a program could be processed on the user's computer, while the remaining part of the program could be processed on a remote computer. As to data used in a program, it doesn't matter on which computer it is recorded. That is, as long as information about a location of data is clear and its data is available, a location where the data or programs are stored may be anywhere on the computer network. Any well known communication technology can be applied to a communication between each network computer, for example, TCP/IP and HTTP protocols are used. An address of each file (data or program) that is recorded in each storage is specified using DNS, URL, etc. Note that the term “the Internet” used herein implies an intranet and extranet as well. A phrase “access to the Internet” implies accessing to an intranet and extranet as well. The term “computer network” implies a computer network that can be publicly accessed and a computer network that can only be accessed privately.

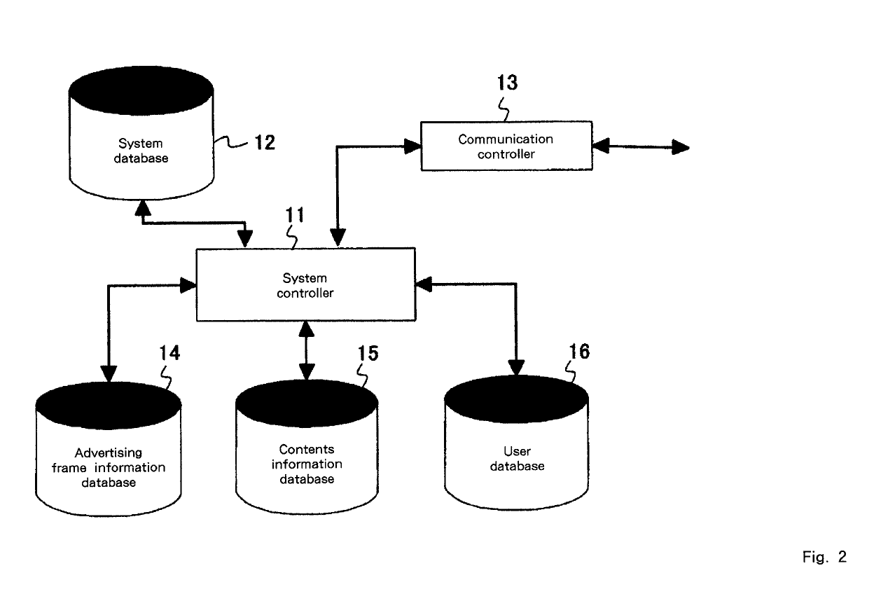

FIG. 2 is a block diagram showing an outline of the configuration of the system management server 10. The system management server 10 comprises a system controller 11, a system database 12, a communication controller 13, an advertising frame information database 14, a contents information database 15, and a user database 16. The system controller 11 controls a computer system of the system management server 10. For example, it controls data communication via the communication controller 13. The system database 12 stores programs and data necessary for system control of the system management server 10. The communication controller 13 interfaces the communication network 50 with the system management server 10. The advertising frame information database 14 stores the advertising frame information described later. The contents information database 15 stores the digital contents information described later. The user database 16 stores the information about a user of the present system.

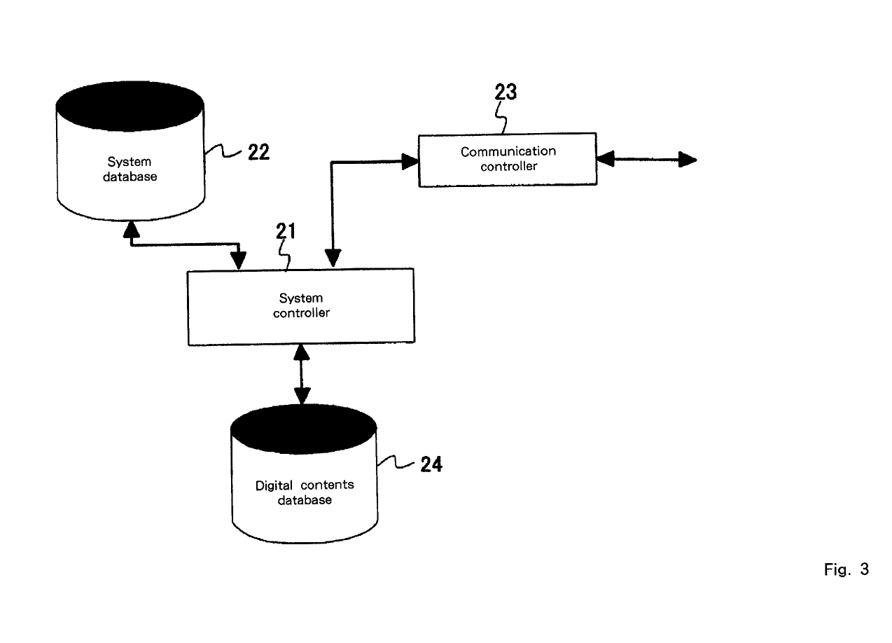

FIG. 3 is a block diagram showing an outline of the digital contents management server 20. The digital contents management server 20 comprises a system controller 21, a system database 22, a communication controller 23, and a digital contents database 24. The system controller 21 controls a computer system of the digital contents management server 20. The system database 22 stores programs and data necessary for system control of the digital contents management server 20. The communication controller 23 interfaces the communication network 50 with the digital contents management server 20. The digital contents database 24 stores the digital contents described later.

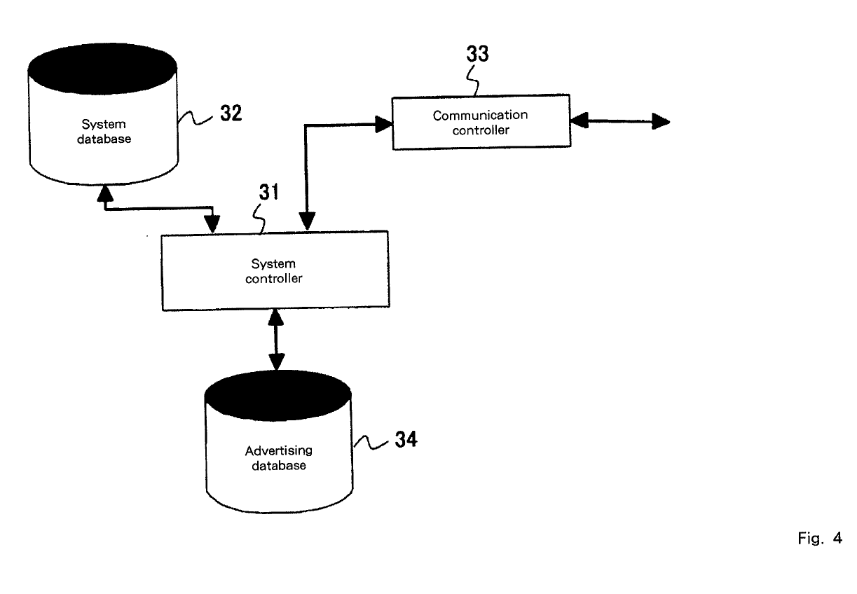

FIG. 4 is a block diagram showing an outline of the advertising data management server 30. The advertising data management server 30 comprises a system controller 31, a system database 32, a communication controller 33, and an advertising database 34. The system controller 31 controls a computer system of the advertising data management server 30. The system database 32 stores programs and data necessary for system control of the advertising data management server 30. The communication controller 33 interfaces the communication network 50 with the advertising data management server 30. The advertising database 34 stores the advertising data described later.

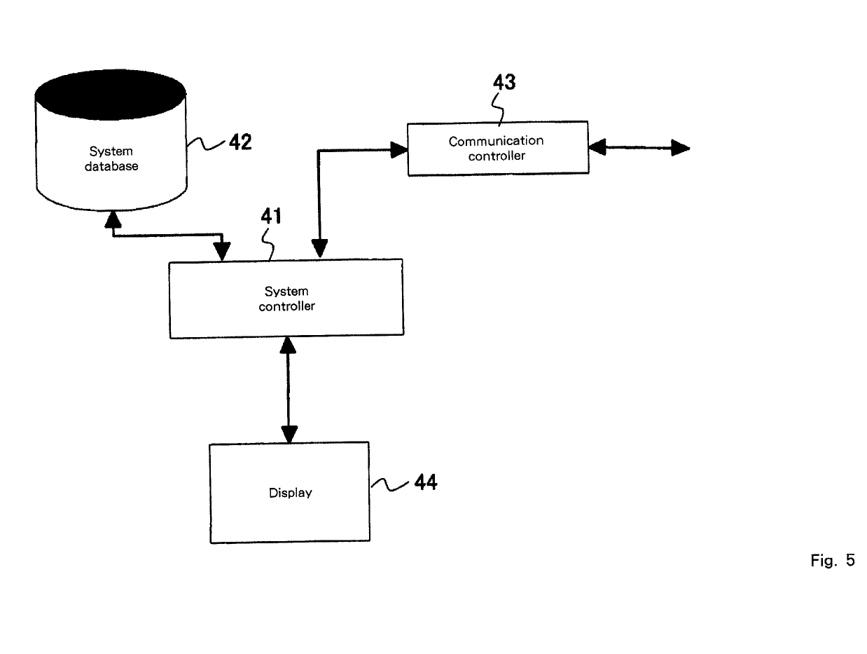

FIG. 5 is a block diagram showing the user terminal 40. The user terminal 40 comprises a system controller 41, a system database 42, a communication controller 43, and a display 44. The system controller 41 controls a computer system of the user terminal 40. The system database 42 stores programs and data necessary for system control of the user terminal 40. The communication controller 43 interfaces the communication network 50 with the user terminal 40. The display 44 displays and outputs images and music of the digital contents described later.

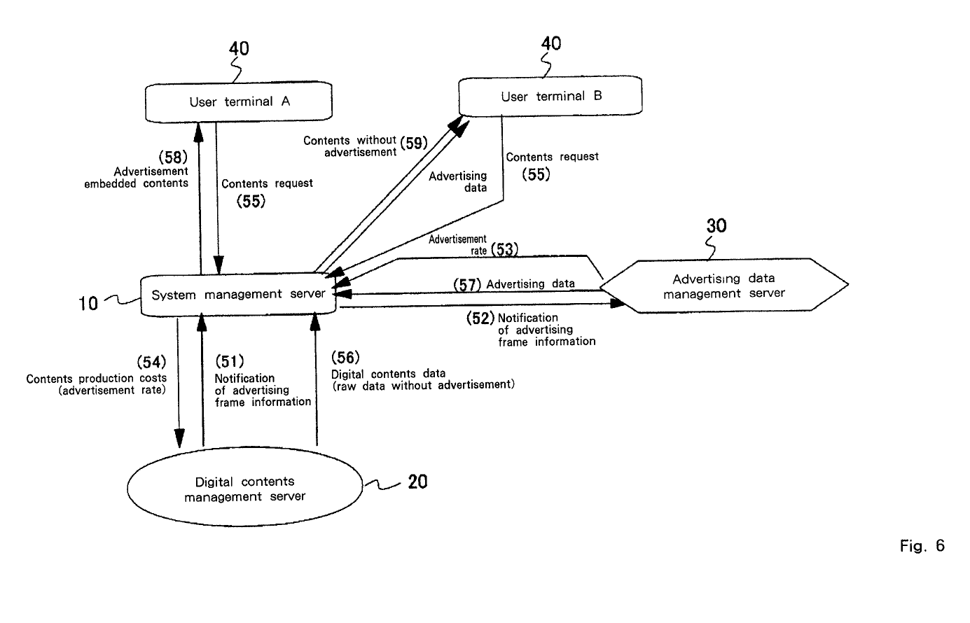

FIG. 6 is a block diagram illustrating an example of operations of the present advertising system. The contents produced by the contents producer is stored in the digital contents database 24 of the digital contents management server 20. The digital contents according to the present invention embeds the advertising frame, as described later. That is, the present invention assigns the advertising frame to an object included in the contents and then introduces audio or visual data (i.e., advertising data) relating to goods for advertisement into the advertising frame. When the advertising data embedded contents are reproduced, the contents are output as music and an image including the advertisement.

A contents owner (including a contents producer, an agent) who hopes to sell the advertising frame entrusts the system provider with the sales and notifies the system management server 10 of the advertising frame information (51). The system provider publishes the advertising frame information, using the system management server 10 or any other computer system, for example. Then, the advertiser (including agent) who accessed the published advertising frame information offers the purchase of the advertising frame to the system provider. If the transaction of the advertising frame reaches an agreement, the system provider notifies the advertising data management server 30 of the advertiser of the advertising frame information (52). The advertiser pays the advertisement rate to the system manager in exchange for the acquisition of the advertising frame information (53). Then, the advertiser produces the advertising data on the basis of the advertising frame information and records the advertising data on the advertising database 34 of the advertising data management server 30. The payment of the advertisement rate doesn't need to be in exchange for the acquisition of the advertising frame information. For example, it may be paid each time the contents are delivered to a user. The advertisement rate is paid to the contents owner from the system manager as the production costs of the contents (54).

On the other hand, the system manager (the system management server 10) delivers the contents in response to a request (55) from a user (the user terminal 40). For the delivery of the contents, the system management server 10 responds to the request (55) from the user terminal 40 and issues a request for the contents to the digital contents management server 20, then reads the digital contents from the digital contents database 24 (56). At the same time, the system management server 10 issues a request for the advertising data to the advertising data management server 30, and then reads the advertising data from the advertising database 34 (57). Then, the system management server 10 delivers the digital contents and the advertising data to the user terminal 40. There are two methods for delivering the digital contents and the advertising data, that is, one is that the system management server 10 introduces the advertising data into the advertising frame and then delivers the advertising data embedded contents (58), the other is that the system management server 10 delivers the contents and the advertising data separately and then the user terminal 40 introduces the advertising data into the contents (59).

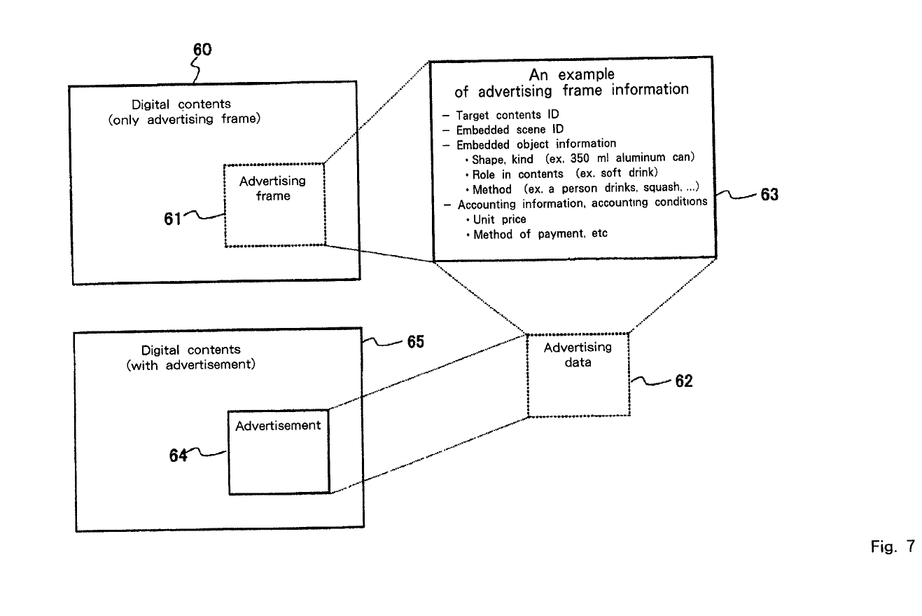

FIG. 7 is a diagram showing a concept of embedding an advertising frame into the digital contents and introducing the advertising data into the advertising frame. In the digital contents 60 that are produced by the contents producer, there is embedded an advertising frame 61 defined by the contents producer. As for the advertising frame 61, there is introduced the advertising data 62 that was produced separately. The advertising data 62 is produced on the basis of the constraints of the advertising frame information 63. When the advertising data 62 is introduced into the advertising frame 61, the digital contents 60 becomes the digital contents 65 with an advertisement. Upon reproducing the digital contents 65 with an advertisement, the advertisement 64 is reproduced integral with the contents.

The advertising frame 61 is, for example, the information of an object that appears in the digital contents. That is, the information that shapes an object in the contents, which is necessary to display or reproduce the object, is managed independently as an advertising frame 61. Upon producing the digital contents, this allows producing the digital contents 60 without considering the contents of the advertising data 62, if only determining the specification of the advertising frame 61. On the other hand, as long as complying with the constraints of the advertising frame information 63, it is possible to produce the advertising data 62 independent of the digital contents 60. That is, the advertising frame 61 plays a role of connecting the digital contents 60 with the advertising data 62.

The advertising data 62 is the contents of the advertisement that matches the advertising frame 61. For example, if the advertising frame 61 is what specifies the shape of an image object, the advertising data 62 is image data. If the advertising frame 61 is what specifies the time and rate of an acoustic object, the advertising data 62 is acoustic data. If the advertising frame 61 is what specifies the scene, shape and method of a moving image object (i.e., movement of an object such as the object rotating, squashing, etc.), the advertising data 62 is a moving image of data that is restricted to these scenes, shape and method. Moreover, even when the advertising data 62 is not introduced, object data at the destination may be embedded in advance in the advertising frame 61, in order to establish the contents. In this case, upon introducing the advertising data 62, the advertising data 62 is superposed onto the destination data or the advertising data 62 replaces the destination data.

The advertising frame information 63 may include, for example, ID (identification code) of the target contents, ID of the embedded scene, information of the embedded object, accounting information, and accounting conditions.

The ID of the target contents and ID of the embedded scene are referred to when introducing the advertising data 62 into the digital contents 60.

The information of the embedded object is utilized as the conditions for restricting the advertising data 62 when producing the advertising data 62. For example, they are the shape, kind of the embedded object, and its role in the contents, and a method of the object. If the object is a can for beverage use, the shape is contour information of the can, while the kind is an aluminum can of 350 ml, for example. The role in the contents is, for example, soft drinks, while the method is, for example, that a person drinks it or that it is squashed in the scene.

The accounting information and accounting conditions are, for example, the unit price of the advertisement and a method of payment, respectively. They are provided for reference when purchasing the advertising frame 61.

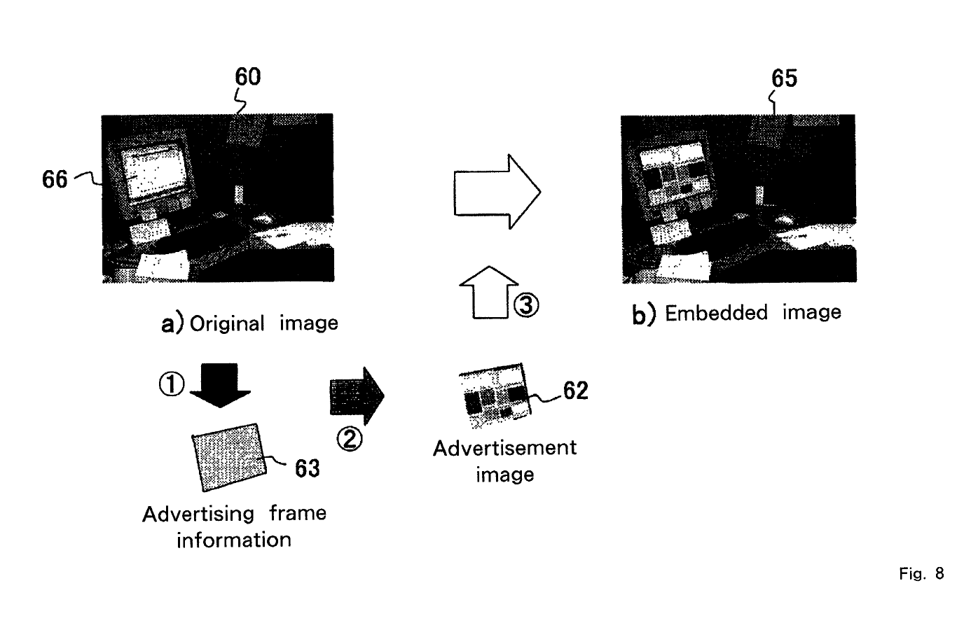

FIG. 8 is a diagram showing a concrete example of an advertising frame. Here is shown an object that is a two-dimensional texture. An object, which is a display target of the advertising, is a screen display of a CRT, wherein there is no movement in the object (movement method) and no change of the shape. First, the advertising frame information 63 is extracted from the digital contents 60 (original image)( (1) ). The advertising frame information 63 is the contour of the CRT screen. Note that the destination data 66 is mounted in the original image. The advertising data 62 is produced so as to match the advertising frame information 63 ( (2) ). In this example, the advertising data 62 is a plane image that is defined by the contour of the object (i.e., the shape of the CRT screen). Then, the advertising data 62 is attached to the original image, subsequently the digital contents 65 with an advertisement is displayed ( (3) ).

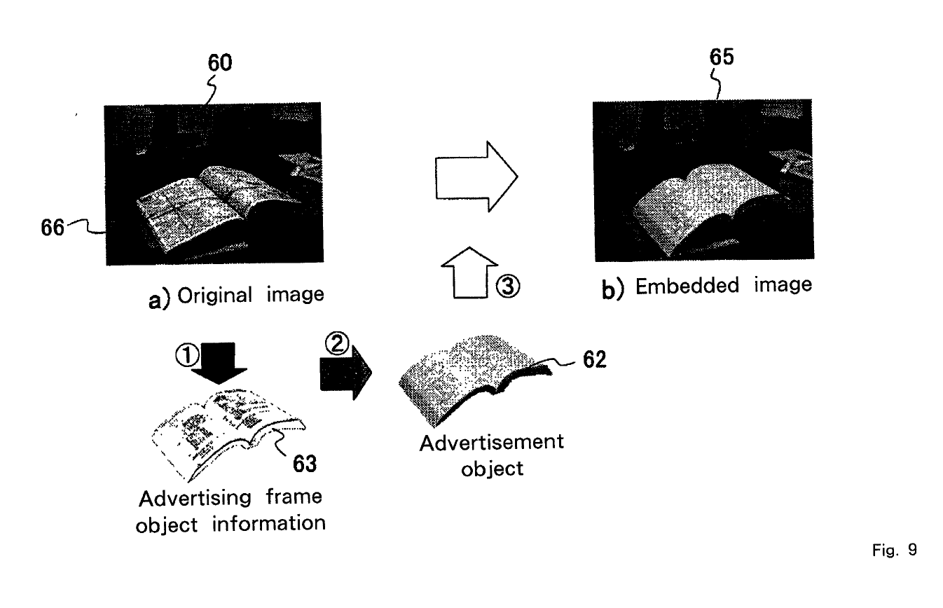

FIG. 9 is a diagram showing a concrete example of another advertising frame. Here, an object serving as a display target of the advertising is an open book. There is no movement (movement method) in the object, however, the shape changes. First, the advertising frame information 63 is extracted from the digital contents 60 (original image)( (1) ). The advertising frame information 63 is the contour of the book and a curved surface shape. Note that the destination data 66 is mounted in the original image. The advertising data 62 is produced so as to match the advertising frame information 63 ( (2) ). In this example, since the object is a book, its open surface shape may change. Hence, the advertising data is produced as a texture that can be attached to the curved surface. Then, the advertising data 62 is attached to the original image, subsequently the digital contents 65 with an advertisement is displayed ( (3) ).

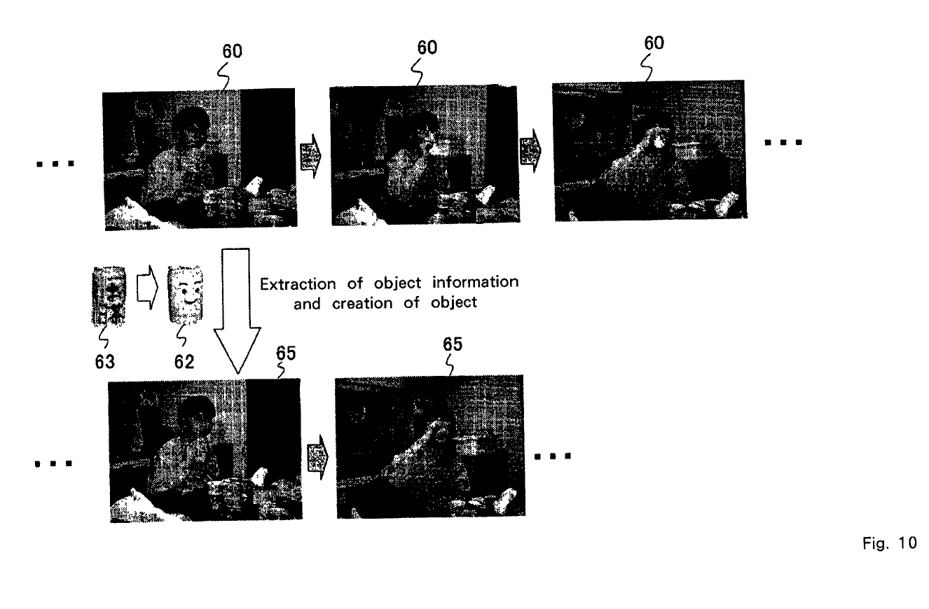

FIG. 10 is a diagram showing a further concrete example of an advertising frame. Here, an object serving as a display target of the advertising is a can. There is included a movement method in the object. As with the above case, the advertising frame information 63 (where the destination data is introduced) is extracted from the digital contents 60 (original image). Then, the advertising data 62 is produced so as to match the advertising frame information 63. Then, the advertising data 62 is introduced into the original image, subsequently the digital contents 65 with an advertisement is displayed. Note that the shown advertising data is a trade mark.

In this way, according to the present invention, incorporating the advertising frame 61 in the digital contents, the digital contents 60 can be produced without specifying the advertising contents. In addition, the advertising data 62 can be produced separately from the production of the digital contents 60. Further, as long as the conditions that the advertising frame 61 defines are met, the advertising data with any contents can be produced. The advertising data can be introduced into the contents not only at the production time but also at any timing after the production. Due to these favorable effects, the advertiser doesn't need to participate in the production of the contents from an early stage, but can implement an effective advertising by purchasing the advertising frame 61 when needed. In addition, he can change the advertising contents depending on the delivery destination of the contents. The contents producer can sell the advertising frame even after the production of the contents.

When the digital contents 60 are produced with each object managed in advance such as a game, the advertising frame 61 is determined referring to the class information of each object. When an image is generated using MPEG 4 or MPEG 7 standard for example, the advertising frame 61 is determined referring to the information of the object descriptor.

Moreover, the contents need not be produced as the digital contents that are managed every object from the beginning. For example, for a typical video image and an image using the MPEG 1 or MPEG 2 standard, an object can be produced using a technique for extracting an object from an original image, such as the video enrichment technique. The advertising frame 61 is formed by adding annotation information to the extracted object (so-called annotation technique).

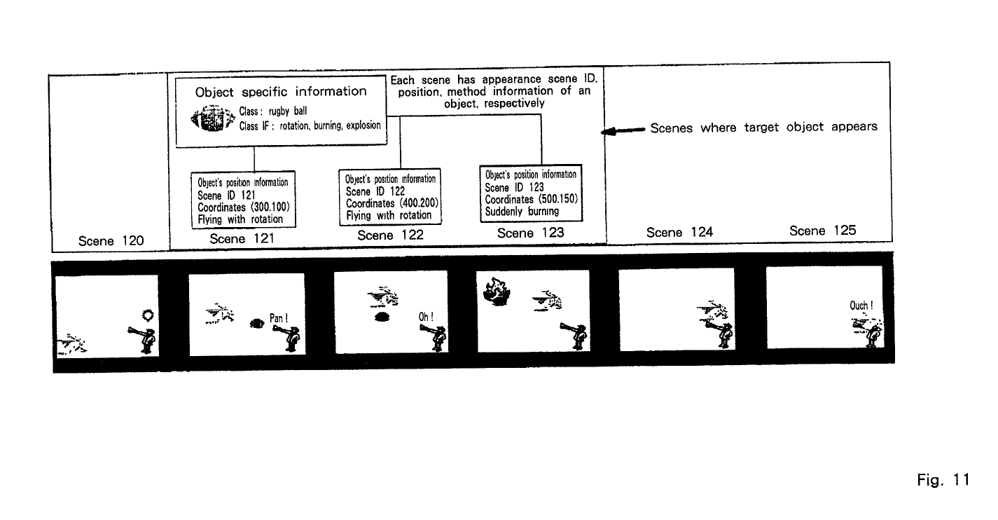

Annotation information includes, as specific information of an object, class information of the object and interface information relating to the object class, and as a set of object appearance information, an appearance scene ID, a position of the object in the scene, and a method applied to the object. FIG. 11 is a diagram showing an example where annotation information is applied. A rugby ball is shown as an object, wherein annotation information attached to this object is exemplified. There are a scene ID, position coordinates, and a method that are attached as annotation. The object (i.e., rugby ball) appears in the scene 121 and displayed at the position specified by the coordinates with “flying with rotation” (method). In the scene 122, it is displayed at a different position with the same method. In the scene 123, both the position and method changes and the object is displayed such that it burns suddenly. In the scene 124 and thereafter, the rugby ball is not displayed. In this way, it is possible to make an object appear in a specific scene by describing an object using a position and method. Replacing this rugby ball (i.e., the contents of the object) with the advertising data, the advertising data can be displayed at the same position and with the same method as the rugby ball. It is noted that the advertising data may be replaced with the original object or may be superposed onto the higher layer than the original object, whereby the contents with the advertisement are reproduced. In addition, the same technique can be of course applied to the digital contents that are managed on a layer basis. Also, a recording area for the annotation information is arbitrary. The annotation information may be written to an area in a recording medium that is utilized for copy protection of video, or the annotation information may be recorded using a technique for embedding an ID in the image itself (e.g., data hiding technique, electronic watermark technique, etc.). The advertising data generated by the annotation information may be incorporated into the original image, or may be managed separately as external data and reproduced as an image whose layer is different from the original image when the contents are reproduced.

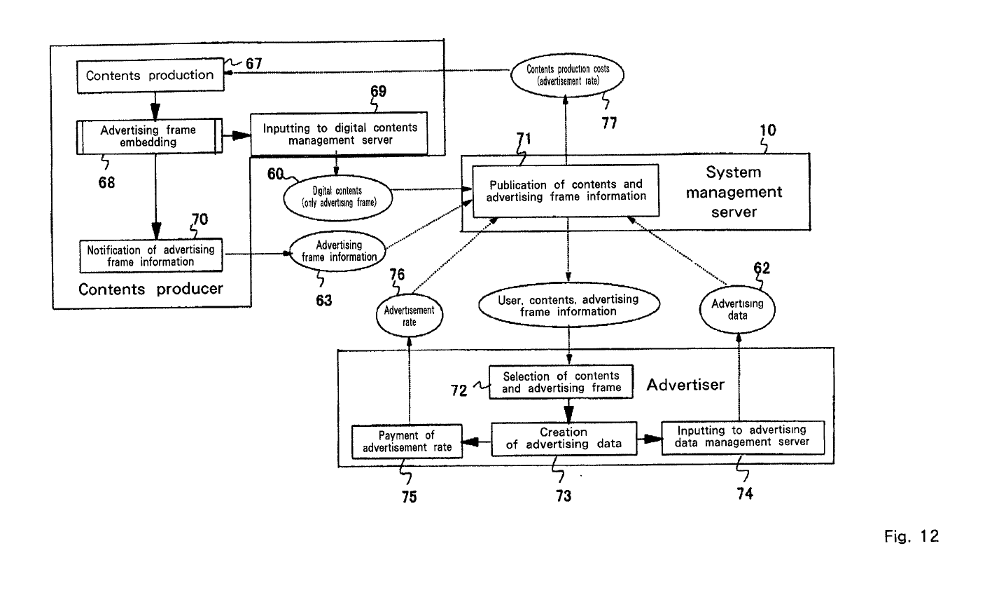

FIG. 12 is a diagram illustrating a flow starting from the contents production to the sales of the advertising frame. At the side of the contents producer, the contents are produced (step 67), and the advertising frame is embedded into the contents (step 68). The step of embedding the advertising frame will be described later in detail. The advertising frame embedded digital contents 60 are input to the digital contents management server 20 and stored in the digital contents database 24 (step 69). Then, the advertising frame information 63 is notified to the system management server 10 (step 70). As the premise of the inputting of the digital contents 60 and notification of the advertising frame information 63, the contents producer and the system provider have agreed on the commission of sales of the advertising frame. The commission involves various kinds of conditions such as the authentication of the contents producer, and limitation clauses relating to sales of the advertising frame. Further, the digital contents 60, which is stored in the digital contents database 24, are read by the system management server 10 upon request of a user. The digital contents 60 in which only the advertising frame is embedded may be sent to the system management server 10 at this stage, in order to transact the advertising frame 61.

At the side of the system provider, the advertising frame information 63 is published, which was notified from the contents producer (step 71). Upon the publication of the advertising frame information 63, other information may be added in order to proceed with the transaction smoothly, including the information about the digital contents 60, an owner of the contents, a user to whom the contents be delivered, etc. Such accompanying information is helpful for the advertiser to purchase the advertising frame. The publication is performed, for example, using a home page of the Internet.

The advertiser can access the published advertising frame information 63. The advertiser selects and purchases the A desired advertising frame among the published information (step 72). An application for purchase and a declaration of intention for purchase are made on a home page. Also, e-mail and other communication means may be used for conveying an application for purchase and a declaration of intention for purchase. If the system provider and the advertiser agree on the transaction of the advertising frame, a contract is established. Let alone the advertisement rate, this contractual coverage may include the delivery frequency, delivery region, delivery time, and time zone of the contents, and further the narrowing down of users of the contents, conditions for distribution of the advertisement, and penalty conditions. Moreover, the consent of the contents owner may be added as a condition. The advertiser who purchased the advertising frame creates the advertising data 62 that matches the advertising frame, with referring to the advertising frame information 63 (step 73). The created advertising data 62 is input to the advertising data management server 30 and stored in the advertising database 34 (step 74). The stored advertising data 62 is read by the system management server 10 upon request of the contents user. At the same time, the advertiser pays the advertisement rate to the system provider (step 75). A part of the advertisement rate 76 paid by the advertiser is returned to the contents producer as the contents production costs 77. Upon transaction of the advertising frame, the system provider can collect handling fees.

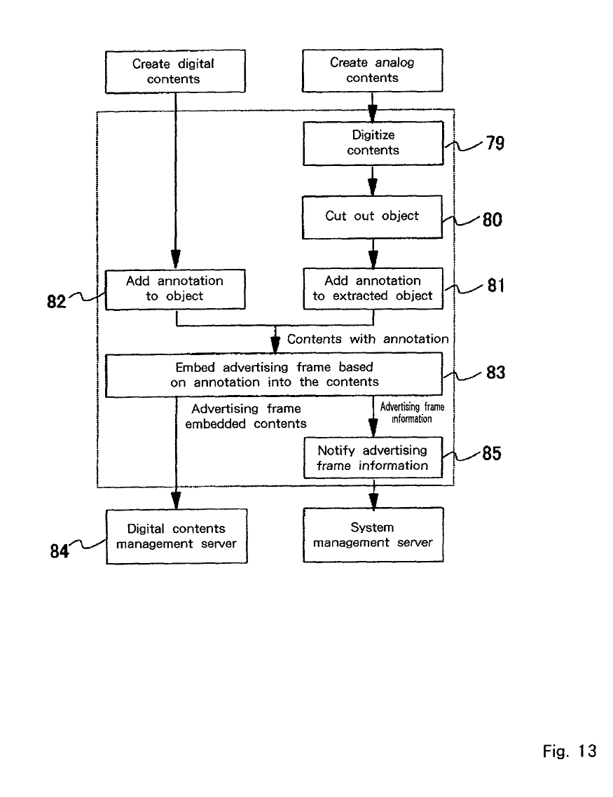

FIG. 13 is a flowchart showing an example of the step of embedding an advertising frame. There are shown two cases, wherein the original contents in which the advertising frame is to be embedded are digital contents and analog contents, respectively.

When the original contents are analog contents, digitization processing is performed on the original contents (step 79), then the object is cut out (step 80). For digitization and cutting out of the object, the aforementioned video enrichment technique can be used. Thereafter, an annotation is added to the extracted object (step 81). Addition of the annotation is performed as mentioned before. If the original contents are digital contents, the original contents already include an object, thus an annotation is added to this object (step 82). Next, the advertising frame based on the annotation is embedded into the contents (step 83). For example, an object descriptor of the MPEG 4 or an object generated from analog contents is associated with the annotation. Then, the advertising frame embedded contents are stored in the digital contents management server 20 (step 84), while the advertising frame information is notified to the system management server 10 (step 85).

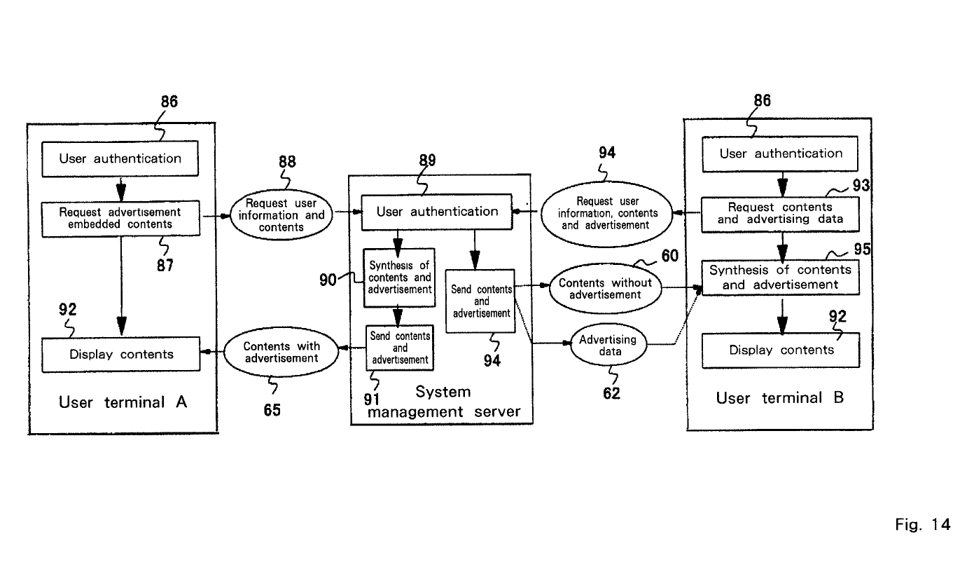

FIG. 14 is a diagram illustrating a flow when a user looks at the digital contents. Here are shown two cases, that is, one is to synthesize the contents and the advertisement at the system management server (see user terminal A), the other is to synthesize them at the user terminal (see user terminal B).

When the contents and the advertisement are synthesized at the system management server, the user terminal A authenticates the user (step 86), then issues a request for the advertisement embedded contents to the system management server (step 87). Upon this request, a user information may be sent together (step 88). In response to the request for the contents, the system management server authenticates the user using the user database (step 89), then performs synthesis processing of the contents and the advertising data (step 90). The step 90 will be described later in detail. Thereafter, the advertisement embedded contents 65 are sent to the user terminal A (step 91). The user terminal A displays the received advertisement embedded contents 65 to the display 44 of the user terminal A (step 92).

On the other hand, when the contents and the advertisement are synthesized at the user terminal, the user terminal B authenticates the user (step 86), then issues a request for the contents and the advertising data to the system management server (step 93). Upon this request, a user information may be sent together (step 94). In response to the request for the contents, the system management server authenticates the user using the user database (step 89), then performs transmission processing of the contents and the advertising data (step 94). This transmission processing includes acquiring the contents data 60 without the advertisement from the digital contents database 24 of the contents management server 20 and acquiring the advertising data 62 from the advertising database 34 of the advertising data management server 30, then sending these to the user terminal B, respectively. Receiving the contents data 60 and the advertising data 62, the user terminal B synthesizes them (step 95), and then sends the advertisement embedded contents 65 to the display 44 of the user terminal B (step 92).

In the user authentication step (step 89) in the system management server, a user terminal step is identified of its kind to determine which of the above methods be used to synthesize the advertising data.

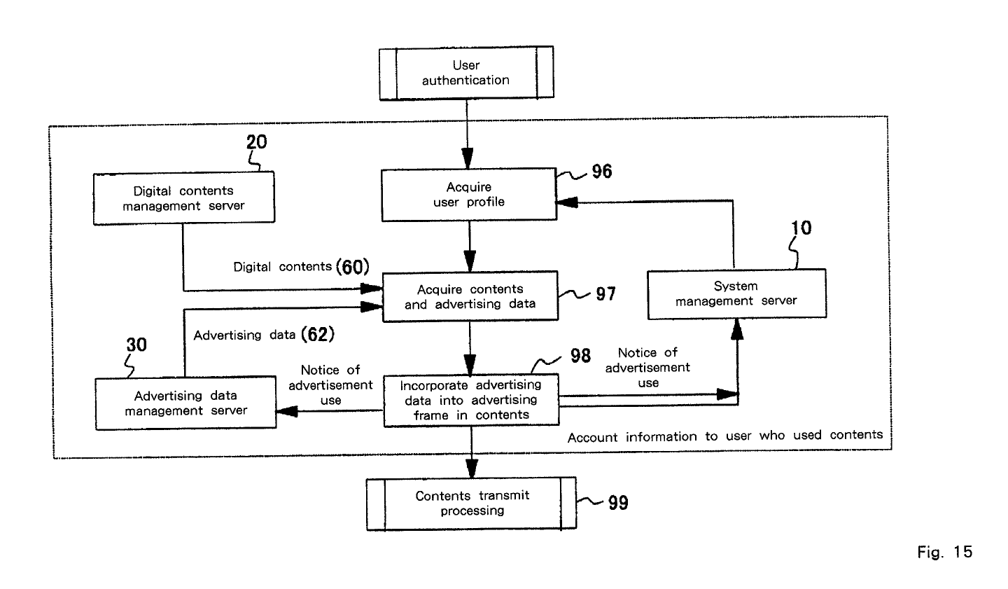

FIG. 15 is a flowchart of an example of synthesis processing of step 90 shown in FIG. 14. After user authentication, a user profile is acquired from the user database 16 of the system management server 10 (step 96). The user profile is used to provide information to an advertiser. Next, the advertising frame embedded digital contents 66 are acquired from the digital contents database 24 of the digital contents management server 20. Also, the advertising data 62 is acquired from the advertising database 34 of the advertising data management server 30 (step 97). Then, the advertising data 62 is incorporated into the advertising frame 61 in the contents (step 98), whereby the advertising data embedded contents 65 are sent to the user terminal 40 (user terminal A) from the system management server 10 (step 99). Then, notice of advertisement use is sent to the advertising data management server 30, and the advertisement use record and accounting information of the user who used the contents are recorded in the user database 16 of system management server 10.

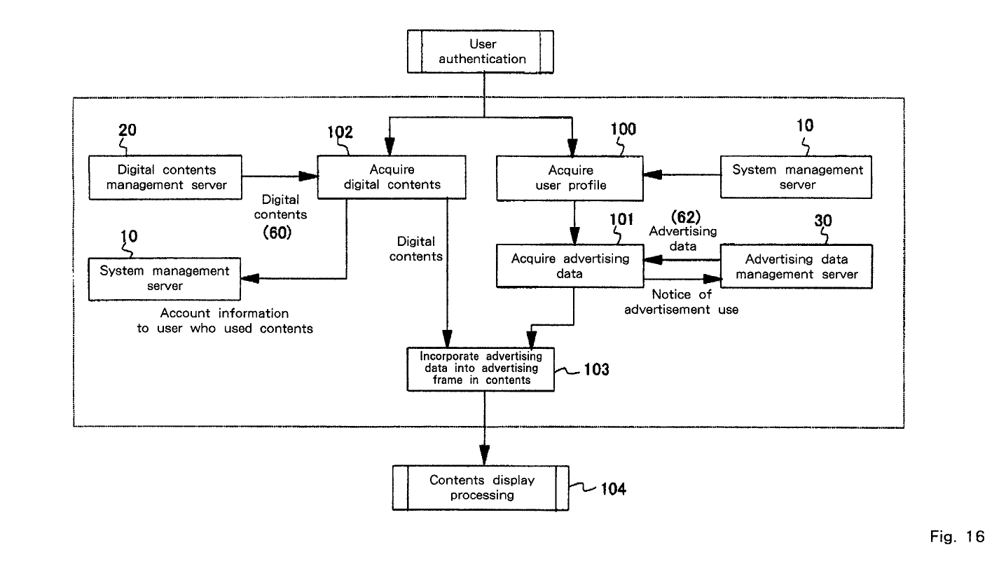

FIG. 16 is a flowchart of an example of synthesis processing of step 95 shown in FIG. 14. After user authentication, the user terminal B acquires a user profile from the user database 16 of the system management server 10 (step 100). Thereafter, the user terminal B acquires the advertising data 62 from the advertising database 34 of the advertising data management server 30 and sends notice of advertisement use to the advertising data management server 30 (step 101). In parallel with these processing, the user terminal B acquires the advertising frame embedded digital contents 60 from the digital contents database 24 of the digital contents management server 20, and records the advertisement use record of the user who used the contents in the user database 16 of system management server 10 (step 102). Then, the user terminal B incorporates the advertising data 62 into the advertising frame 61 in the contents 60 (step 103), and displays the advertising data embedded contents 65 to the display 44 of the user terminal B (step 104).

In the case of synthesis processing shown in FIG. 16, the advertising data 62 and the digital contents 60 once acquired can be cached in the system of the user terminal B. That is, the cached advertising data 62 and digital contents 60 are reused. Further, the advertising data 62 and the digital contents 60 need not be sent at the same time. The digital contents 60 may be sent in advance, and only the advertising data 62 may be sent when reproduced at the user terminal B.

As for the user authentication, an individual is strictly specified by an authentication technique using a fingerprint, or a simple authentication is performed using a user ID and a password or the like. According to the tolerance level of the authentication, detailed control becomes possible, such as cutting of scenes of violence. It is also possible to restrict the utilization time by providing a timer in the user terminal.

Notice of the user information is not the essential requirement of the present invention, however, an advertiser can get marketing information from the user information and utilize it for the future advertising activity.

Moreover, using the user information (particularly, information specified to an individual using a strict authentication technique), personalization becomes possible wherein the advertising contents are changed individually. This allows developing a highly individuated advertising activity compared with the advertising in the broadband contents delivery, thereby bringing about high advertising effects.

As mentioned above, according to the advertising system of the present invention, it is possible to deal with the advertising data (the contents of the advertisement) and the digital contents separately. This allows forming a market of advertising frames as mentioned above, because only an advertising frame becomes the target of transactions. In addition, since the transaction of advertising frames is not constrained by the production time and announcement time of the contents, an advertising frame should be transacted at a proper economic value according to marquee and popularity. That is, for the contents that arouse interest after the announcement, the value of the advertising frame is highly evaluated, while for the contents to the contrary, a reasonable price is formed on the basis of the principle of supply and demand.

The present invention has been described on the basis of its preferred embodiments, however, the present invention is not limited to those embodiments described above, and various modifications are possible without departing from the spirit and scope of the present invention.

As mentioned above, according to the present invention, there is provided a technique for dynamically changing the advertising contents in an advertising form integral with the contents that can expect a great advertising effect. Furthermore, there is provided means for transacting an advertising frame embedded in the contents.

What is claimed is:

1. A method for advertising using a computer system or network that provides a contents database for recording image contents and an advertising database for recording advertising data, comprising:
generating image contents including advertising frame information and recording the contents to a contents database;
generating advertising data corresponding to the advertising frame information and recording the data to an advertising database;
synthesizing the contents and the advertising data; and
displaying synthesized contents to a terminal of a contents user.

2. The method according to claim 1, wherein the generated contents are managed on an object basis, and the advertising frame information is associated with a descriptor of each object.

3. The method according to claim 1, further comprising:
extracting an object from the generated contents, wherein the generated contents are not managed on an object basis; and
associating the extracted object with corresponding advertising frame information.

4. The method according to claim 2, wherein the object is an image object of a static image, a moving image, or an acoustic object.

5. The method according to claim 3, wherein the object is an image object of a static image, a moving image, or an acoustic object.

6. The method according to claim 1, said synthesizing comprising storing advertising data as contents data of an object associated with the advertising frame information.

7. The method according to claim 1, said synthesizing comprising replacing contents data of an object with advertising data.

8. The method according to claim 1, said synthesizing comprising superimposing advertising data onto contents data of an object.

9. The method according to claim 1, said synthesizing comprising:
delivering pre-synthesized contents data and the advertising data to a contents user separately; and
synthesizing the pre-synthesized data and the advertising data at a terminal system of the contents user.

10. The method according to claim 1, said synthesizing comprising synthesizing the generated contents before the generated contents are delivered to a contents user.

11. An advertising system, comprising:
a contents database for recording image contents that includes an advertising frame information;
an advertising database for recording advertising data corresponding to the advertising frame information;
means for delivering the contents and advertising data to a terminal of a contents user;
means for synthesizing the contents and the advertising data; and
means for presenting the recorded contents and the advertising data to the contents user.

12. The advertising system according to claim 11, wherein the recorded contents are managed on an object basis, and the advertising frame information is associated with a descriptor of each object.

13. The advertising system according to claim 11, wherein the recorded contents include an object that is extracted from the prerecorded contents, the recorded contents not being managed on an object basis, and wherein the extracted object is associated with corresponding advertising frame information.

14. The advertising system according to claim 11, wherein the object is an image object of a static image, a moving image, or an acoustic object.

15. The advertising system according to claim 11, the synthesizing means comprising means for storing advertising data as contents data of an object associated with advertising frame information.

16. The advertising system according to claim 11, the synthesizing means comprising means for replacing contents data of an object with advertising data.

17. The advertising system according to claim 11, the synthesizing means comprising means for superimposing advertising data onto contents data of an object.

18. The advertising system according to claim 11, the synthesizing means comprising means of synthesizing the contents and the advertising data in a delivery source system.

19. The advertising system according to claim 11, the synthesizing means comprising means of synthesizing the contents and the advertising data in a terminal of a contents user.

20. A computer-readable recording media embodying a program executable by a computer, the program comprising:
means for delivering image contents that include an advertising frame information to a contents user;
means for delivering advertising data corresponding to the advertising frame information to the contents user;
means for synthesizing the contents and the advertising data; and
means for presenting the synthesized contents to the contents user.

21. A computer-readable recording media embodying a program executable by a computer, the program comprising:
means for reading image contents from a contents database, the contents including advertising frame information;
means for reading advertising data from an advertising database, the advertising data corresponding to the advertising frame information;
means for synthesizing the contents and the advertising data;
means for delivering the synthesized contents to a contents user; and
means for presenting the delivered contents to the contents user.

22. The computer-readable recording media according to claim 20, wherein the program further comprises means for extracting an object from the contents, the contents not being managed on an object basis, and associating the extracted object with the advertising frame information.

23. The computer-readable recording media according to claim 20, wherein the program further comprises means for associating a descriptor of an object of the contents with the advertising frame information, in which the contents are managed on an object basis.

24. A transaction method for an advertising frame associated with an object constituting image contents, comprising:
presenting sales information of the advertising frame using a computer or computer system;
an applicant, who has been looking for an advertisement referring to the sales information, offering to purchase the advertising frame; and
when an agreement regarding the advertising frame is transacted, communicating information related to the advertising frame to the applicant who has purchased the advertising frame.

25. The transaction method according to claim 24, further comprising:
producing advertising data corresponding to the advertising frame information;
synthesizing the contents and the advertising data; and
presenting the synthesized contents to a contents user.

26. The transaction method according to claim 25, wherein said presenting sales information is performed by a system provider upon request of an owner of the contents or an owner of the advertising frame, and the delivery of the contents and the advertising data is performed by the system provider.

27. The transaction method according to claim 26, wherein the system provider acquires the contents from an owner of the contents or an owner of the advertising frame, and acquires the advertising data from a purchaser of the advertising frame, the method further comprising:
synthesizing the contents and the advertising data; and
then delivering the synthesized contents to the contents user.

28. The transaction method according to claim 26, wherein the system provider acquires the contents from an owner of the contents or an owner of the advertising frame, and acquires the advertising data from a purchaser of the advertising frame, the method further comprising delivering contents data associated with the advertising frame information and the advertising data separately to the contents user.

29. A transaction system for an advertising frame associated with an object constituting image contents using a computer or computer system, comprising:
means for presenting sales information of the advertising frame;
means for receiving an offer of an applicant who has referred to the sales information and hopes to purchase the advertising frame; and
means for, when an agreement regarding the advertising frame is transacted, communicating advertising frame information corresponding to the advertising frame to the applicant who has purchased the advertising frame.

30. The transaction system according to claim 29, further comprising:
means for synthesizing the contents and advertising data corresponding to the advertising frame information; and
means for presenting the synthesized contents to a contents user.

31. A computer-readable recording media embodying a program for instructing a computer to conduct a transaction of an advertising frame associated with an object constituting image contents, the program comprising:
means for presenting sales information of the advertising frame;
means for receiving an offer of an applicant who has referred to the sales information and hopes to purchase the advertising frame; and
means for, when an agreement regarding the advertising frame is transacted, communicating advertising frame information of the advertising frame to the applicant who has purchased the advertising frame.

32. The recording media according to claim 31, the program further comprising:
means for synthesizing the contents and advertising data; and
means for presenting the synthesized contents to a contents user.
